(19) United States
(12) Patent Application Publication
(10) Pub. No.: US 2023/0104794 A1
(43) Pub. Date: Apr. 6, 2023

(54) APPARATUS AND METHOD FOR ADDITIVELY MANUFACTURING AN OBJECT

(71) Applicant: Sodick Co., Ltd., Kanagawa (JP)

(72) Inventors: Mikio KANEKO, Kanagawa (JP); Katsuhiko KOBAYASHI, Kanagawa (JP); Kyokatsu MOTOYA, Kanagawa (JP)

(73) Assignee: Sodick Co., Ltd., Kanagawa (JP)

(21) Appl. No.: 17/880,681

(22) Filed: Aug. 4, 2022

(30) Foreign Application Priority Data
Oct. 4, 2021 (JP) 2021-163650

(51) Int. Cl. B29C 64/393; B29C 64/25; B29C 64/245; B29C 64/268; B29C 64/153

(52) U.S. Cl. CPC B29C 64/393; B29C 64/25; B29C 64/245; B29C 64/268; B29C 64/153; B33Y 10/00

(57) ABSTRACT

The apparatus for additively manufacturing includes a chamber, a work table, a base plate, an imaging apparatus, an image processing apparatus, and a control apparatus. The imaging apparatus images a first region including an entire build region on the work table to obtain a first image which the image processing apparatus analyzes to obtain position information of the base plate in the build region. The control apparatus calculates coordinates of a detection target point as first calculated coordinates from the position information. The imaging apparatus images a second region being a part of the first region and including the first calculated coordinates to obtain a second image which the image processing apparatus analyzes to obtain position information of the detection target point in the build region. The control apparatus calculates coordinates of the detection target point as second calculated coordinates from the position information of the detection target point.

### CROSS REFERENCE TO RELATED APPLICATIONS

This application claims priority under 35 USC 119 from Japanese Patent application 2021-163650 filed on Oct. 4, 2021, the disclosure of which is incorporated by reference herein.

### BACKGROUND

### Technical Field

The disclosure relates to an apparatus and a method for additively manufacturing an object. In particular, the disclosure relates to an apparatus and a method for detecting the position of a base plate.

### Description of Related Art

Various methods are known in the additive manufacturing of a three-dimensional object. For example, in a chamber filled with inert gas, a metal material powder is supplied to the upper surface of a base plate disposed in a build region on a work table to form a material layer. Then, the material layer is sintered or melted by irradiating a predetermined position of the material layer with a laser beam or an electron beam using an irradiation apparatus to form a solidified layer. By repeating the formation of such a material layer and a solidified layer, the solidified layers are laminated to produce a desired three-dimensional object.

The base plate is used to protect the work table and facilitate the fixation of the solidified layer. After the building is completed, the object is removed from the work table while being integrated with the base plate. The object is then completely detached from the base plate or becomes a product with all or part of the base plate left. Patent Literature 1 discloses an additive manufacturing method for improving the shape accuracy of a product in which a sintered body is integrally formed on a base plate.

### RELATED ART

### Patent Literature

[Patent Literature 1] Japanese Patent Publication No. 6564111.

### SUMMARY

### Technical Problem

In order to irradiate a predetermined position of the material layer on the base plate with a laser beam or an electron beam with high accuracy, it is necessary to accurately grasp the position of the base plate in the build region and appropriately set the coordinate system of the irradiation apparatus. For example, when any corner or center of the base plate in a plan view is used as a reference point in setting the coordinate system, it is necessary to grasp the position of the reference point. A contact-type measuring device such as a touch probe, a dial test indicator, or an energization detector may be used to detect the position of the base plate. Position detection using a contact-type measuring device has problems such as the accuracy being easily affected by the skill of the operator, a risk of damage to the measuring device due to an operation error, and the time required to set the measuring device.

As another method, for example, there is a method of obtaining an image of a build region by an imaging apparatus equipped with a CCD camera or the like and performing image processing on the obtained image to detect the position of the base plate in the build region. When such non-contact type position detection is performed, the above-mentioned problems related to the contact type measuring device may be avoided, but there are also problems peculiar to the non-contact type. For example, when the size of the build region or the base plate is relatively large, it is necessary to increase the distance between the camera and the object to be imaged in order to image a wider area, which may reduce the detection accuracy. In particular, when the color or surface quality of the base plate is close to the color or surface quality of the build region, or when the shape of the base plate is complicated, it becomes difficult to detect the position by image processing.

The disclosure has been made in view of such circumstances, and the disclosure provides an apparatus and a method for additively manufacturing that are capable of suppressing a decrease in accuracy in position detection of a base plate.

### Solution to Problem

According to the disclosure, provided is an apparatus for additively manufacturing, including: a chamber; a work table; a base plate; a material layer forming apparatus; an irradiation apparatus; an imaging apparatus; an image processing apparatus; and a control apparatus. A build region is provided on the work table. The chamber covers the build region. The base plate is disposed in the build region. The material layer forming apparatus forms a material layer on an upper surface of the base plate by supplying material powder. The irradiation apparatus forms a solidified layer by irradiating the material layer with a laser beam or an electron beam. The imaging apparatus images a first region including the entire build region to obtain a first image. The image processing apparatus analyzes the first image to obtain position information of the base plate in the build region. The control apparatus calculates coordinates of at least one detection target point as first calculated coordinates from the position information of the base plate. The imaging apparatus images a second region which is a part of the first region and includes the first calculated coordinates to obtain a second image. The image processing apparatus analyzes the second image to obtain position information of the detection target point in the build region. The control apparatus calculates coordinates of the detection target point as second calculated coordinates from the position information of the detection target point.

### Effects

In the apparatus for additively manufacturing according to the disclosure, the coordinates of the detection target point are calculated as the first calculated coordinates from the analysis result of the first image. Then, the second image is obtained by imaging the second region including the first calculated coordinates, and the coordinates of the detection target point are calculated as the second calculated coordinates from the analysis result of the second image. Since the second region is smaller than the first region, it is possible to set the distance between the imaging apparatus and the detection target point to be smaller at the time of imaging the second region than at the time of imaging the first region. As a result, the position information of the detection target point may be obtained from the second image with higher accuracy, and the coordinates of the detection target point may be obtained as the second calculated coordinates with higher accuracy than the first calculated coordinates.

Hereinafter, various embodiments of the disclosure will be illustrated. The embodiments shown below may be combined with one another.

It is preferable that the apparatus for additively manufacturing further includes a camera moving apparatus. The imaging apparatus includes an overall imaging camera and a partial imaging camera. The overall imaging camera is fixed in the chamber and images the first region to obtain the first image. The partial imaging camera is movably provided in the chamber and images the second region to obtain the second image. The control apparatus creates a movement command of the partial imaging camera using the first calculated coordinates. The camera moving apparatus moves the partial imaging camera according to the movement command.

It is preferable that the apparatus for additively manufacturing includes a fully automatic mode and a semi-automatic mode as operation modes. The control apparatus includes a mode switching part, a calculation part, and an input part. The mode switching part switches the operation mode. In the fully automatic mode, the calculation part calculates the coordinates of the detection target point as the first calculated coordinates from the position information of the base plate to create the movement command, and in the semi-automatic mode, the calculation part calculates the coordinates of the detection target point as the first calculated coordinates from additional position information of the base plate input by the input part to create the movement command.

It is preferable that the apparatus for additively manufacturing further includes a manual mode as the operation mode. An operation part for operating the camera moving apparatus is provided. The camera moving apparatus moves the partial imaging camera according to the movement command in the fully automatic mode and the semi-automatic mode, and moves the partial imaging camera according to an operation of the operation part by an operator in the manual mode.

It is preferable that in the apparatus for additively manufacturing, the detection target point is located on an outer edge of the base plate in a plan view.

It is preferable that the detection target point is located at a corner of the base plate in a plan view.

According to another aspect of the disclosure, provided is a method for additively manufacturing an object, including: a material layer forming step; a solidifying step; first and second image obtaining steps; first and second image analysis steps; and first and second calculation steps. In the material layer forming step, in a chamber covering a build region provided on a work table, material powder is supplied to an upper surface of a base plate disposed in the build region to form a material layer. In the solidifying step, the material layer is irradiated with a laser beam or an electron beam to form a solidified layer. In the first image obtaining step, a first region including the entire build region is imaged to obtain a first image. In the first image analysis step, the first image is analyzed to obtain position information of the base plate in the build region. In the first calculation step, coordinates of a detection target point on the base plate are calculated as first calculated coordinates from the position information of the base plate. In the second image obtaining step, a second region which is a part of the first region and includes the first calculated coordinates is imaged to obtain a second image. In the second image analysis step, the second image is analyzed to obtain position information of the detection target point in the build region. In the second calculation step, coordinates of the detection target point are calculated as second calculated coordinates from the position information of the detection target point.

### BRIEF DESCRIPTION OF THE DRAWINGS

FIG. 1 is a schematic configuration diagram of an apparatus 100 for additively manufacturing according to an embodiment of the disclosure.

FIG. 2 is a perspective view of a material layer forming apparatus 3.

FIG. 3 is a perspective view of the recoater head 11 from above.

FIG. 4 is a perspective view of the recoater head 11 from below.

FIG. 5 is a schematic configuration view of the irradiation apparatus 13.

FIG. 6 is a plan view showing a state in which the base plate 81 is disposed in the build region R.

FIG. 7 is a plan view showing a state in which the base plate 81 having one of the corners chamfered is disposed in the build region R.

FIG. 8 is another schematic configuration view of the apparatus 100 for additively manufacturing according to an embodiment of the disclosure, and is a view showing a configuration of the apparatus 100 for additively manufacturing of FIG. 1 as viewed from the right side.

FIG. 9 is a view showing an example of the imaging regions of the overall imaging camera 61 and the partial imaging camera 62 in the disposition of the base plate 81 of FIG. 6.

FIG. 10 is a view showing another example of the imaging region of the partial imaging camera 62.

FIG. 11 is a view showing another example of the imaging region of the partial imaging camera 62.

FIG. 12 is a view showing a second image obtained by imaging the second region A2 of FIG. 9.

FIG. 13 is a block diagram showing a configuration of a control apparatus 9.

FIG. 14 is a flow chart showing a procedure for setting a building coordinate system.

FIG. 15 is a view showing a method of manufacturing a three-dimensional object using the apparatus 100 for additively manufacturing.

FIG. 16 is a view showing a method of manufacturing a three-dimensional object using the apparatus 100 for additively manufacturing.

### DESCRIPTION OF EMBODIMENTS

Hereinafter, embodiments of the disclosure will be described with reference to the drawings. The features shown in the embodiments shown below may be combined with one another. In addition, the disclosure is independently established for each feature.

1. Apparatus 100 for Additively Manufacturing

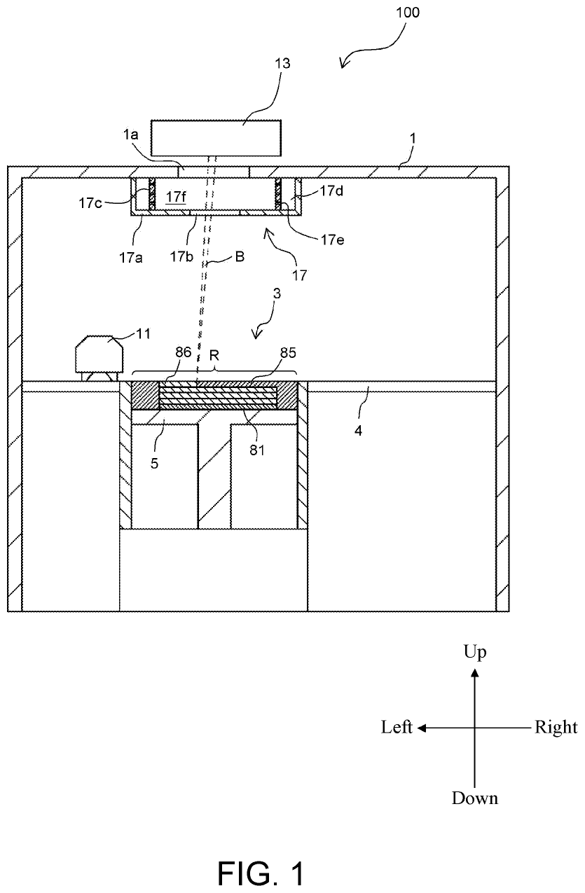

FIG. 1 is a schematic configuration diagram of an apparatus 100 for additively manufacturing according to this embodiment. The apparatus 100 for additively manufacturing includes a chamber 1, a material layer forming apparatus 3, and an irradiation apparatus 13. A desired three-dimensional object is formed by repeating the formation of a material layer 85 and a solidified layer 86 in a build region R provided on a work table 5 disposed in the chamber 1. In the following description, the direction toward the front of FIG. 1 is defined as “front” of the apparatus 100 for additively manufacturing, and the direction toward the back of FIG. 1 is defined as “rear” of the apparatus 100 for additively manufacturing. Then, the up-down direction of FIG. 1 is defined as the up-down direction (vertical direction) of the apparatus 100 for additively manufacturing, and the left-right direction of FIG. 1 is defined as the left-right direction of the apparatus 100 for additively manufacturing.

1.1. Chamber 1

The chamber 1 covers the build region R, which is the region where the three-dimensional object is formed. The inside of the chamber 1 is filled with an inert gas having a predetermined concentration supplied from an inert gas supply apparatus (not shown). Herein, the inert gas is a gas that does not substantially react with the material layer 85 or the solidified layer 86, and is selected according to the type of material, and for example, nitrogen gas, argon gas, and helium gas may be used. The inert gas including fumes generated during the formation of the solidified layer 86 is discharged from the chamber 1, and is supplied to the chamber 1 to be reused after the fumes are removed in a fume collector. The fume collector is, for example, an electrostatic precipitator or a filter.

A window 1a serving as a transmission window for a laser beam B is provided on the upper surface of the chamber 1. The window 1a is made of a material that may transmit the laser beam B. Specifically, the material of the window 1a is selected from quartz glass, borosilicate glass, germanium, silicon, zinc selenium, potassium bromide crystals, or the like, depending on the type of laser beam B. For example, when the laser beam B is a fiber laser or a YAG laser, the window 1a may be made of quartz glass.

Further, on the upper surface of the chamber 1, a pollution prevention apparatus 17 is provided to cover the window 1a. The pollution prevention apparatus 17 includes a cylindrical housing 17a and a cylindrical diffusion member 17c disposed in the housing 17a. An inert gas supply space 17d is provided between the housing 17a and the diffusion member 17c. Further, on the bottom surface of the housing 17a, an opening 17b is provided inside the diffusion member 17c. The diffusion member 17c is provided with a large number of pores 17e, and a clean inert gas supplied to the inert gas supply space 17d fills a clean chamber 17f through the pores 17e. Then, the clean inert gas filled in the clean chamber 17f is ejected downward from the pollution prevention apparatus 17 through the opening 17b. With such a configuration, it is possible to prevent the fume from adhering to the window 1a and to remove the fume from the irradiation path of the laser beam B.

1.2. Material Layer Forming Apparatus 3

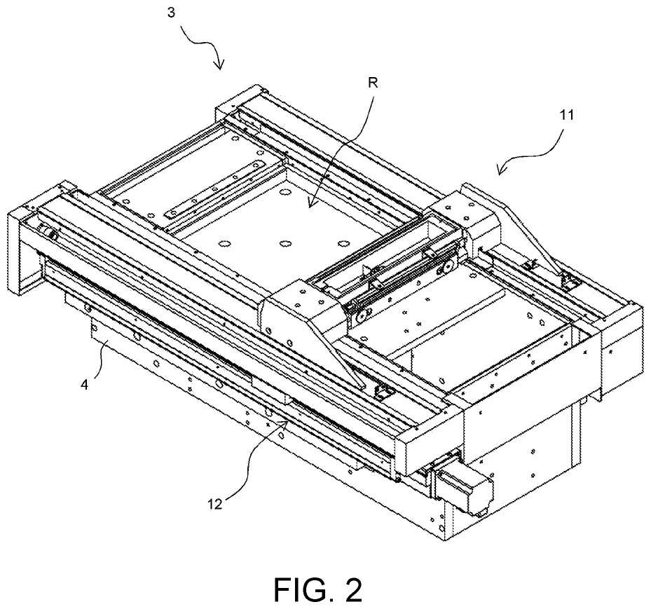

The material layer forming apparatus is provided inside the chamber 1. As shown in FIG. 2, the material layer forming apparatus 3 includes a base 4 and a recoater head 11 disposed on the base 4. The recoater head 11 is configured to be reciprocally movable in the horizontal uniaxial direction by a recoater head drive apparatus 12.

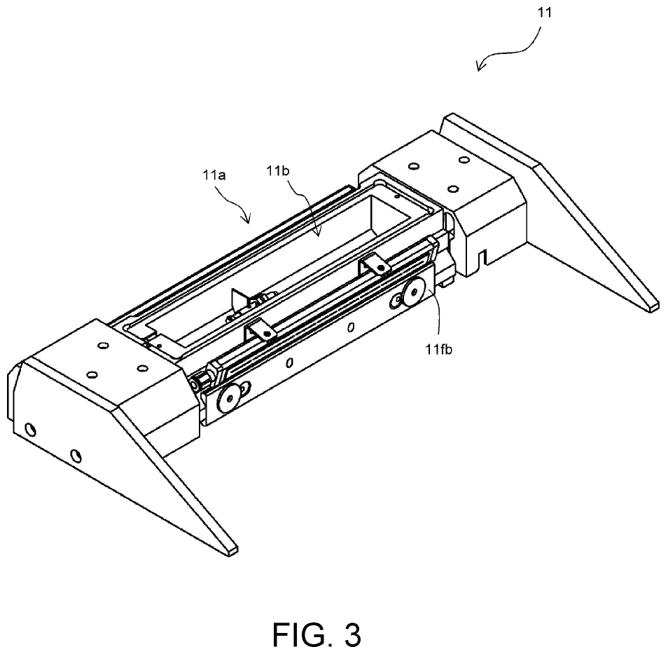

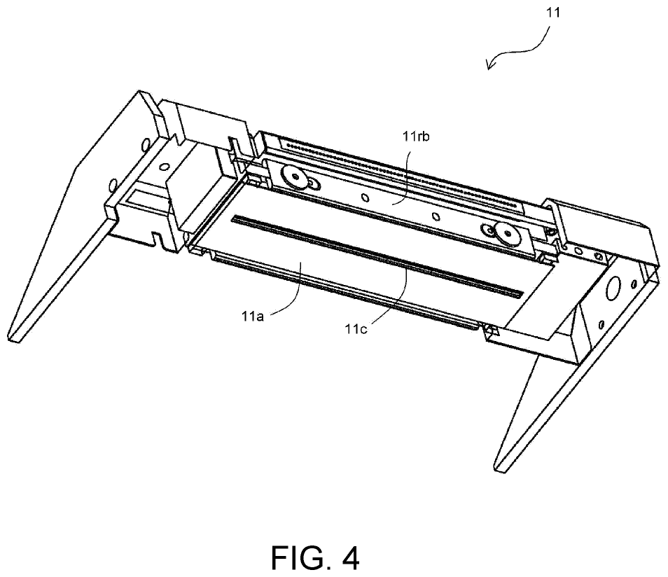

As shown in FIGS. 3 and 4, the recoater head 11 includes a material storage part 11a, a material supply port 11b, and a material discharge port 11c. The material supply port 11b is provided on the upper surface of the material storage part 11a and serves as a receiving port for the material powder supplied from a material supply unit (not shown) to the material storage part 11a. The material discharge port 11c is provided on the bottom surface of the material storage part 11a, and discharges the material powder in the material storage part 11a. The material discharge port 11c has a slit shape extending in the longitudinal direction of the material storage part 11a. Flat blades 11fb and 11rb are provided on two side surfaces of the recoater head 11. The blades 11fb and 11rb flatten the material powder discharged from the material discharge port 11c to form the material layer 85.

As shown in FIGS. 1 and 2, the build region R is located on the work table 5, and a desired three-dimensional object is formed in the build region R. The work table 5 is driven by a work table drive apparatus and may move in the vertical direction. At the time of building, a base plate 81 is disposed in the build region R, and the material powder is supplied to the upper surface of the base plate 81 to form the material layer 85.

1.3. Irradiation Apparatus 13

As shown in FIG. 1, the irradiation apparatus 13 is provided above the chamber 1. The irradiation apparatus 13 irradiates the irradiation region of the material layer 85 formed in the build region R with the laser beam B to melt or sinter the material powder and solidify it to form the solidified layer 86.

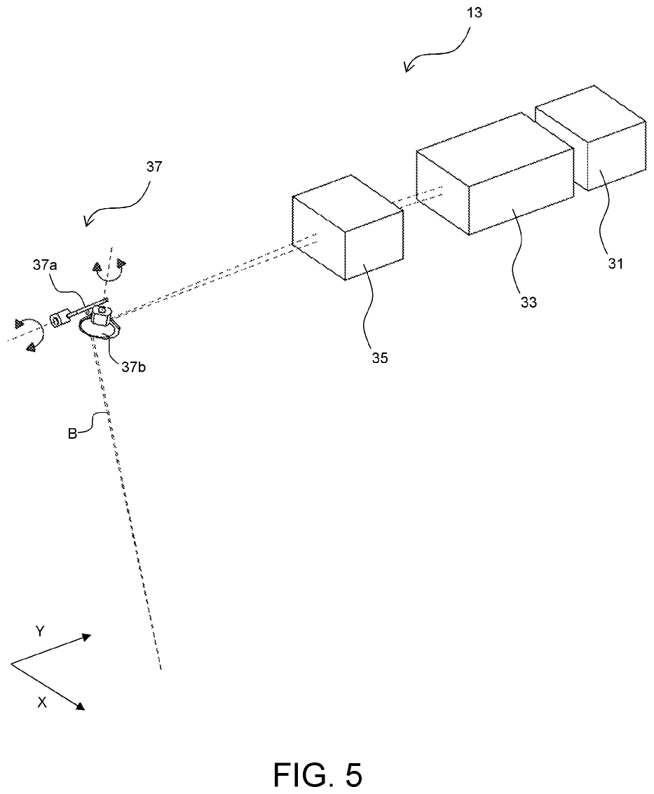

As shown in FIG. 5, the irradiation apparatus 13 includes a light source 31, a collimator 33, a focus control unit 35, and a scanner 37, and is controlled by an irradiation control part 96 (to be described later). The light source 31 generates the laser beam B. The laser beam B may be any type as long as it may sinter or melt the material powder, and is, for example, a fiber laser, a CO2 laser, or a YAG laser. In this embodiment, a fiber laser is used as the laser beam B.

The collimator 33 includes a collimator lens and converts the laser beam B output from the light source 31 into parallel light. The focus control unit 35 includes a focus control lens and a motor that moves the focus control lens back and forth along the optical axis direction, and the focus control unit 35 adjusts the focal position of the laser beam B converted into parallel light by the collimator 33 to adjust the beam diameter of the laser beam B on the surface of the material layer 85.

The scanner 37 is, for example, a galvano scanner, and includes a first galvano mirror 37a and a second galvano mirror 37b, and a first actuator and a second actuator that rotate the first galvano mirror 37a and the second galvano mirror 37b at desired angles, respectively. The laser beam B that has passed through the focus control unit 35 is caused to scan two-dimensionally on the upper surface of the material layer 85 in the build region R by the first galvano mirror 37a and the second galvano mirror 37b. Specifically, according to a building coordinate system (to be described later), the laser beam B is reflected by the first galvano mirror 37a to scan in the X-axis direction, which is the horizontal uniaxial direction in the build region R, and is reflected by the second galvano mirror 37b to scan in the Y-axis direction, which is another horizontal uniaxial direction in the build region R and is orthogonal to the X-axis direction.

The laser beam B reflected by the first galvano mirror 37a and the second galvano mirror 37b passes through the window 1a and irradiates the material layer 85 in the build region R, whereby the solidified layer 86 is formed. The irradiation apparatus 13 is not limited to the above-mentioned form. For example, an f θ lens may be provided instead of the focus control unit 35. Further, the irradiation apparatus 13 may be configured to irradiate an electron beam instead of the laser beam B to solidify the material layer 85. Specifically, the irradiation apparatus 13 may be configured to include a cathode electrode that emits electrons, an anode electrode that converges and accelerates electrons, a solenoid that forms a magnetic field and converges the direction of the electron beam in one direction, and a collector electrode that is electrically connected to the material layer 85 to be irradiated and applies a voltage between the cathode electrode and the material layer 85.

In addition to the above configuration, the apparatus 100 for additively manufacturing may include a machining apparatus (not shown) for performing machining such as cutting in the chamber 1 according to the needs for the solidified layer 86 and the object. The machining apparatus is configured by attaching, for example, a tool (for example, an end mill) for performing machining such as cutting to a machining head, and the machining head is appropriately moved in the horizontal direction and the vertical direction to perform machining on the solidified layer 86 or the object. Further, the tool may be configured to be rotatable by being attached to a spindle of the machining head.

2. Setting a Building Coordinate System

The apparatus 100 for additively manufacturing is preset with a machine coordinate system for designating a position in the build region R. The machine coordinate system is set peculiar to the apparatus 100 for additively manufacturing and is invariant regardless of the building conditions. In addition, in order to irradiate the desired position of the material layer 85 on the base plate 81 with the laser beam B using the irradiation apparatus 13, or to perform machining on the solidified layer 86 or the object on the base plate 81, it is necessary to set the building coordinate system based on the base plate 81 disposed in the build region R prior to building. The building coordinate system is set every time the base plate 81 is replaced or the disposition is changed, and operation commands for the irradiation apparatus 13 and the machining apparatus are created based on the building coordinate system. It is also possible to set the building coordinate system for each apparatus configuring the apparatus 100 for additively manufacturing such as the irradiation apparatus 13 and the machining apparatus.

In order to set the building coordinate system, in this embodiment, in the setting of the building coordinate system, the coordinates of the reference point are specified in the machine coordinate system. Specifically, an image of the base plate 81 disposed in the build region R is obtained by the imaging apparatus, and the coordinates of at least one detection target point in the machine coordinate system are obtained by image analysis. The detection target point in the disclosure refers to a point that is imaged by the imaging apparatus and whose position is detected in image analysis in order to specify the coordinates of the reference point in the machine coordinate system. The coordinates of the reference point are obtained from the coordinates of the detection target point, and for example, the building coordinate system is set with the reference point as the origin. As the reference point of the building coordinate system, for example, a corner or the center of the base plate 81 in a plan view may be selected. Further, as the detection target point, a point that may be detected by image analysis in order to specify the reference point may be appropriately set. If the reference point itself may be detected by image analysis, the reference point may be set as the detection target point. As will be described later, in order to detect the detection target point by image analysis such as edge detection, it is preferable to set the detection target point on an edge configuring the outer edge of the base plate 81 in a plan view, and it is more preferable to set it at a corner of the base plate 81 in a plan view.

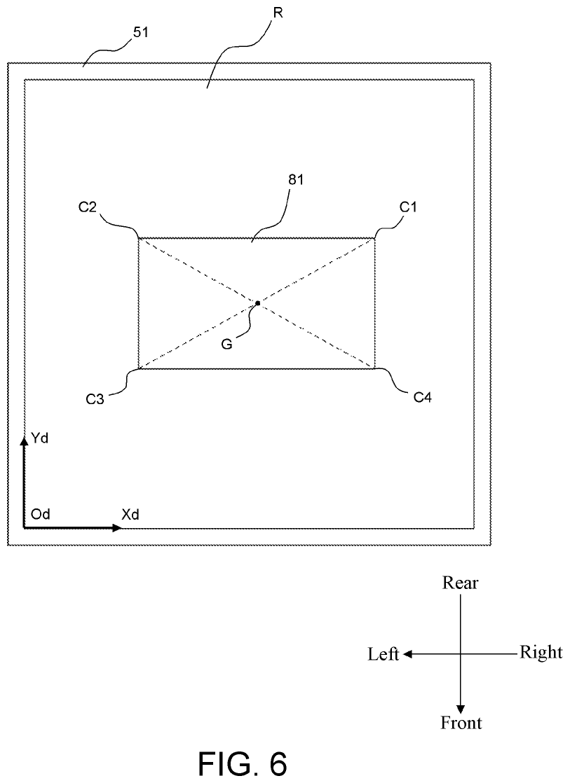

As an example, the determination of the coordinates of the reference point when a rectangular base plate 81 is disposed in the build region R as shown in FIG. 6 will be described. The lower, upper, left, and right directions of FIG. 6 correspond to the front, rear, left, and right directions of the apparatus 100 for additively manufacturing, respectively. In the example of FIG. 6, in the machine coordinate system, the origin Od is the corner located at the intersection of the front end and the left end of the build region R located inside a frame 51 is set as the origin Od, and the front end of the build region R is set as the Xd axis, and the left end is set as the Yd axis. When the corner C2 of the base plate 81 in a plan view is used as the reference point of the building coordinate system, the corner C2 may be set as the detection target point since the corner C2 is relatively easily detected by image analysis. The coordinates of the corner C2, which is the detection target point, are obtained by image analysis, whereby the coordinates of the corner C2 as the reference point are specified.

As another example, the center G of the base plate 81 in a plan view may be used as the reference point of the building coordinate system. When it is difficult to directly detect the center G by image analysis, a point that is easier to detect may be set as a detection target point. For example, when two corners C2 and C4 located at two ends of one diagonal line of the rectangle are set as detection target points, the coordinates of the corners C2 and C4 are obtained by image analysis, and by obtaining the coordinates of the midpoint of the line segment connecting the corners C2 and C4, the coordinates of the center G, which is the reference point, may be specified. Further, instead of the two corners C2 and C4, the same operation may be performed with the two corners C1 and C3 located at two ends of the other diagonal line of the rectangle as the detection target points to specify the coordinates of the center G. Alternatively, with the four corners C1, C2, C3, and C4 as detection target points, the coordinates of these points are obtained by image analysis, and the coordinates of the center G may be specified as the intersection of the line segment connecting the corners C1 and C3 and the line segment connecting the corners C2 and C4.

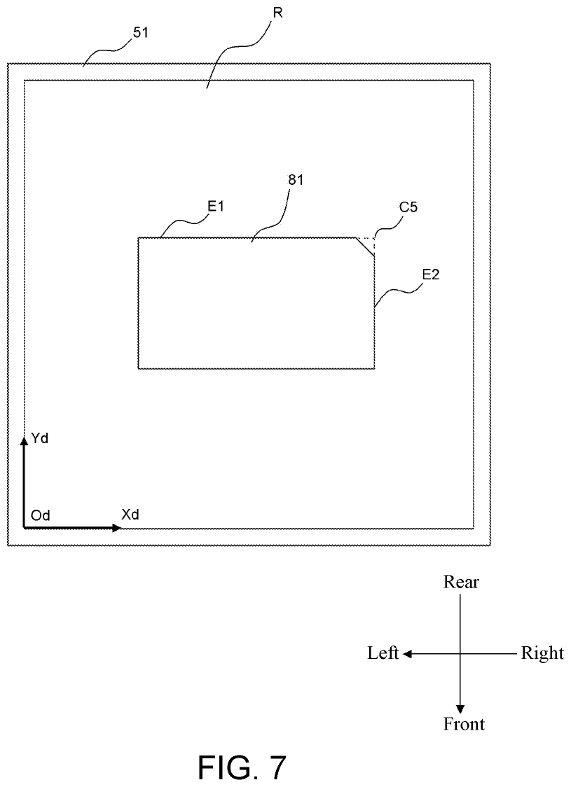

As another example, as shown in FIG. 7, the determination of the coordinates of the reference point when the base plate 81 in which one of the corners of the rectangle is chamfered is disposed in the build region R will be described. In the example of FIG. 7, the machine coordinate system is set in the same manner as in FIG. 6. When the point C5, which is the intersection of the extension lines of the two edges E1 and E2 of the base plate 81 extending from the chamfered part, is used as the reference point and the detection target point of the building coordinate system, the coordinates of the edges E1 and E2 are obtained by image analysis. Then, by obtaining the coordinates of the intersection of the extension lines of the edges E1 and E2, the coordinates of the point C5 which is the reference point and the detection target point may be specified.

3. Imaging Apparatus

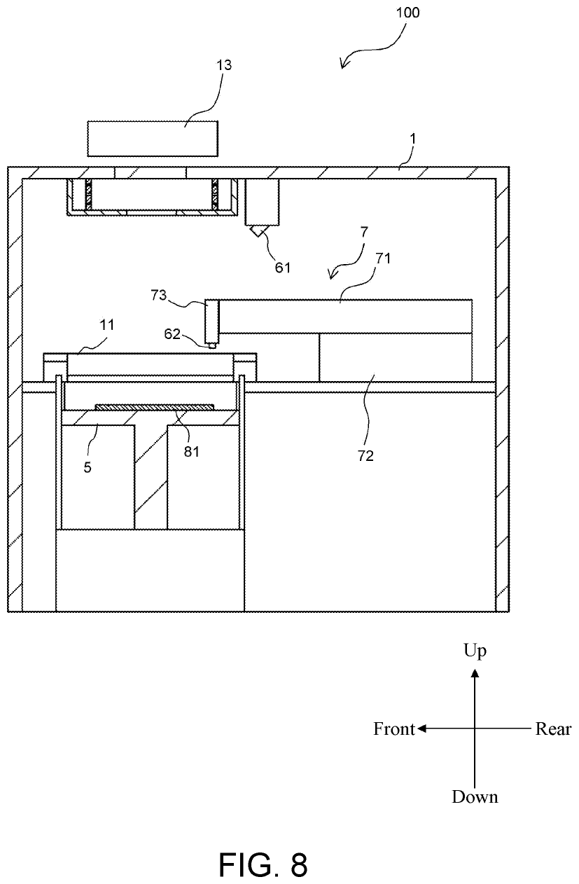

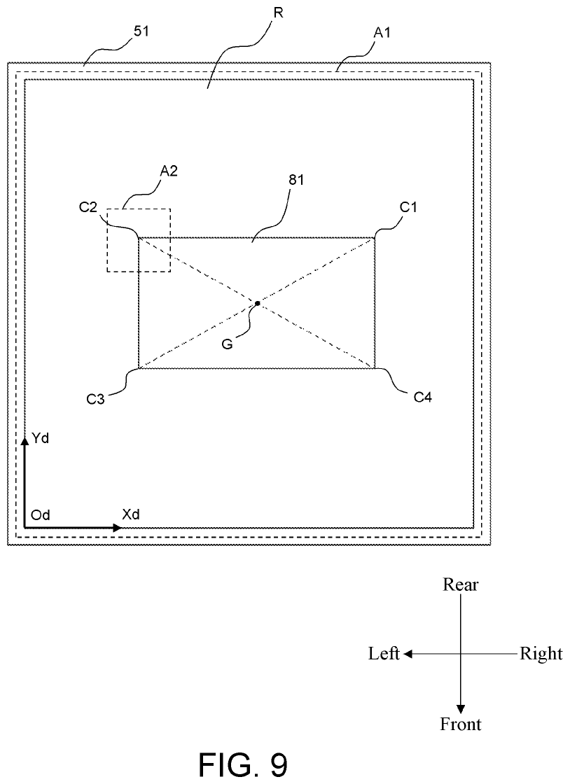

FIG. 8 is another schematic configuration view of the apparatus 100 for additively manufacturing, and is a view showing a configuration of the apparatus 100 for additively manufacturing of FIG. 1 as viewed from the right side. The apparatus 100 for additively manufacturing according to this embodiment includes an imaging apparatus for imaging the build region R from above. The imaging apparatus is, for example, a CCD camera or a CMOS camera. As shown in FIG. 8, the imaging apparatus according to this embodiment includes two cameras, an overall imaging camera 61 and a partial imaging camera 62, which are CCD cameras, and each camera is controlled by an image processing apparatus 43 (to be described later) to take an image. FIG. 9 is a view showing an example of the imaging regions of the overall imaging camera 61 and the partial imaging camera 62 in the disposition of the base plate 81 of FIG. 6.

The overall imaging camera 61 is provided in the chamber 1 and images a first region A1 including the entire build region R to obtain a first image. In order to include the entire build region R in the imaging region, the overall imaging camera 61 needs to be disposed above the build region R at a certain distance from the build region R. In this embodiment, the overall imaging camera 61 is fixed to the ceiling part of the chamber 1. The first image is analyzed by the image processing apparatus 43, and the position information of the base plate 81 in the build region R is obtained. The control apparatus 9 calculates the coordinates of the detection target point in the machine coordinate system as first calculated coordinates from the position information of the base plate 81. Details of these operations by the image processing apparatus 43 and the control apparatus 9 will be described later.

The partial imaging camera 62 is provided in the chamber 1 to be movable at least in the horizontal direction, and images a second region A2 to obtain a second image. The second region A2 is a part of the first region A1 and is set to include the detection target point, in other words, to include the first calculated coordinates obtained by the analysis of the first image. FIG. 9 shows the second region A2 when the corner C2 of the base plate 81 is used as the reference point and the detection target point. The second image is analyzed by the image processing apparatus 43, and the position information of the detection target point in the build region R is obtained. The control apparatus 9 calculates the coordinates of the detection target point as second calculated coordinates from the position information of the detection target point. Details of these operations by the image processing apparatus 43 and the control apparatus 9 will be described later.

The second region A2 imaged by the partial imaging camera 62 is smaller than the first region A1 imaged by the overall imaging camera 61. Therefore, it is possible to set the distance between the partial imaging camera 62 and the build region R at the time of imaging the second region A2, particularly the vertical distance, to be smaller than the distance between the overall imaging camera 61 and the build region Rat the time of imaging the first region A1.

Both the first calculated coordinates and the second calculated coordinates are calculated as the coordinates of the detection target point, but the first calculated coordinates are obtained from the first image obtained by imaging the first region including the entire build region R, and are used to roughly grasp the position of the detection target point in the build region to determine the imaging region (second region A2) of the partial imaging camera 62. In addition, the second calculated coordinates obtained from the second image obtained closer to the build region R are more accurate than the first calculated coordinates obtained by the analysis of the first image. The coordinates of the reference point in the setting of the building coordinate system are specified by using the second calculated coordinates. Therefore, even when the size of the build region or the base plate is large, it is possible to suppress a decrease in the accuracy of position detection.

At least one second region A2 is set according to the position of the detection target point, the conditions such as the color and surface quality of the base plate 81, the required accuracy in detecting the detection target point, and the like. For example, when the corner C2 is used as the reference point and the detection target point in the disposition of the base plate 81 in FIG. 9, the region near the corner C2 as the detection target point may be set as the second region A2.

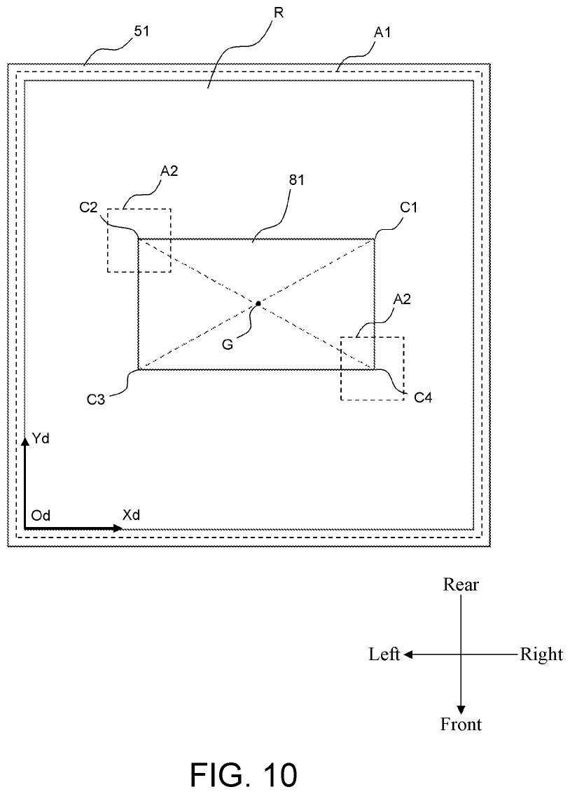

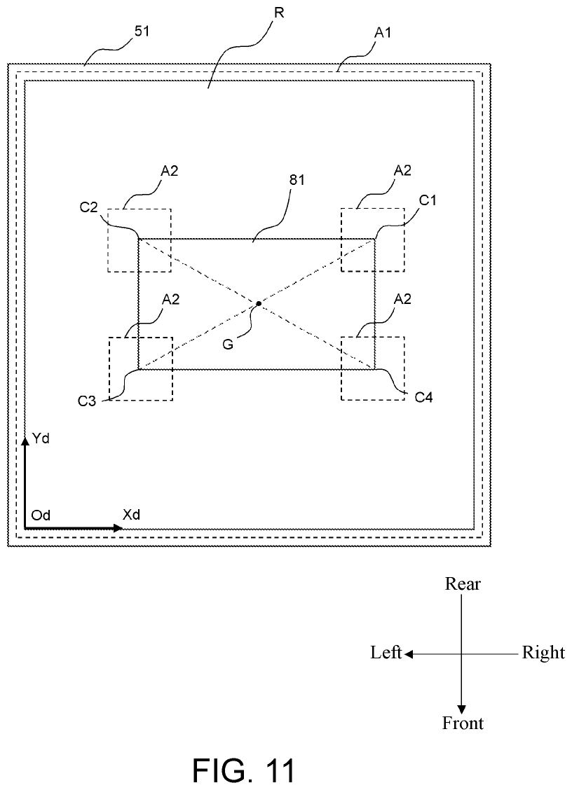

Further, when the center G is set as the reference point and the two corners C2 and C4 are set as the detection target points in the disposition of FIG. 9, as shown in FIG. 10, two regions near the corner C2 and the corner C4 are set as the second regions A2, and each may be imaged by the partial imaging camera 62 to obtain two second images. Further, when the center G is set as the reference point and the four corners C1, C2, C3, and C4 are set as the detection target points in the disposition, as shown in FIG. 11, four regions near each corner are set as the second regions A2, and each may be imaged to obtain four second images. Alternatively, depending on the required detection accuracy and the like, two regions including two adjacent corners C2 and C3 and corners C1 and C4 (or corners C1 and C2 and corners C3 and C4) may be set as the second regions A2, and two second images may be obtained.

When multiple detection target points are set, it is preferable to set the same number of second regions A2 as the detection target points so that each second region A2 includes one detection target point. As a result, the second region A2 may be set sufficiently smaller than the first region A1, and the second calculated coordinates may be obtained with sufficient accuracy as compared with the first calculated coordinates.

The partial imaging camera 62 of this embodiment may be moved by a camera moving apparatus 7. As shown in FIG. 8, the camera moving apparatus 7 has the partial imaging camera 62 attached to one end thereof. The camera moving apparatus 7 includes a first drive mechanism 71 that enables reciprocating movement in one horizontal uniaxial direction in the build region R, and a second drive mechanism 72 to which the first drive mechanism 71 is attached and enables reciprocating movement in another horizontal uniaxial direction orthogonal to the one horizontal uniaxial direction, and is controlled by a moving apparatus control part 98 (to be described later). The partial imaging camera 62 of this embodiment is moved by the first drive mechanism 71 in the front-rear direction of the apparatus 100 for additively manufacturing, and by the second drive mechanism 72 in the left-right direction of the apparatus 100 for additively manufacturing. As a result, the partial imaging camera 62 may be freely moved in the horizontal direction above the build region R, and the second region A2 may be disposed at a position where imaging is possible. The camera moving apparatus 7 may be configured to further move the partial imaging camera 62 in the vertical direction. The camera moving apparatus 7 according to this embodiment includes a third drive mechanism 73 that reciprocally moves the partial imaging camera 62 in the vertical direction. This makes it possible to appropriately adjust the vertical distance between the partial imaging camera 62 and the build region R. The first drive mechanism 71, the second drive mechanism 72, and the third drive mechanism 73 may be configured by using, for example, a linear motor, a cylinder, a ball screw, or a rack and pinion mechanism, respectively.

The configuration of the imaging apparatus is not limited to the above configuration. For example, the first region A1 and the second region A2 may be imaged by one camera provided in the imaging apparatus. In this case, the camera is configured to be horizontally movable and vertically movable by the camera moving apparatus 7.

4. Imaging Processing Apparatus 43

The apparatus 100 for additively manufacturing of this embodiment includes an image processing apparatus 43. The image processing apparatus 43 is used to control the operation of the imaging apparatus and to process the first image and the second image obtained by the imaging apparatus.

The image processing apparatus 43 may be realized by software or hardware. When realized by software, various functions may be realized by a CPU executing a computer program. The program may be stored in a built-in storage part or may be stored in a non-transitory computer-readable recording medium. Further, a program stored in an external storage part may be read out and realized by so-called cloud computing. When realized by hardware, it may be realized by various circuits such as an application specific integrated circuit (ASIC), a field programmable gate array (FPGA), or a dynamically reconfigurable processor (DRP).

4.1. Analysis of First Image

The image processing apparatus 43 causes the overall imaging camera 61 to image the first region based on an operation command from the control apparatus 9 (to be described later), analyzes the first image, and obtains the position information of the base plate 81 in the build region R. The position information of the base plate 81 in the disclosure refers to information necessary for specifying the position of the detection target point in the machine coordinate system.

The image processing apparatus 43 first performs a filter process on the first image as a pre-process for facilitating the detection of the contour of the base plate 81, in other words, the outer edge of the base plate 81 in a plan view. Edge detection is performed on the filter processed first image, and the contour of the base plate 81 is detected. Known methods and algorithms may be applied in the filter process and edge detection.

The image processing apparatus 43 obtains the position of the detected corner on the contour as the position information of the base plate 81. The image processing apparatus 43 according to this embodiment has a function of calibrating the coordinate system, scaling, and rotation peculiar to the overall imaging camera 61 fixed to the ceiling part. In this embodiment, the position of the corner specified in the coordinate system peculiar to the overall imaging camera 61 is converted into the machine coordinate system by using the calibration function, and the result is used as the position information of the base plate 81. The position information of the base plate 81 is not limited to the above example, and for example, the position and length of each edge configuring the detected contour may be used as the position information of the base plate 81. The position information of the base plate 81 thus obtained is sent to the control apparatus 9, and the control apparatus 9 calculates the coordinates of the detection target point as the first calculated coordinates from the position information.

4.2. Analysis of Second Image

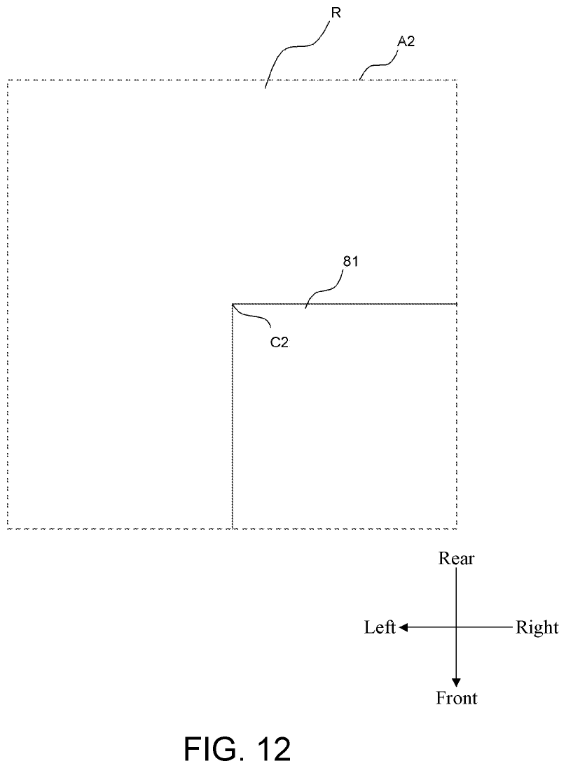

The image processing apparatus 43 causes the partial imaging camera 62 to image the second region based on an operation command from the control apparatus 9, analyzes the second image, and obtains the position information of the detection target point in the build region R. The image processing apparatus 43 performs a filter process and edge detection on the second image in the same manner as the process of the first image, and detects the contour of the base plate 81. The second image includes the contour of the base plate 81 near the detection target point in an enlarged state as compared with the first image. For example, when the second region A2 shown in FIG. 9 is imaged, the second image as shown in FIG. 12 is obtained.

The image processing apparatus 43 obtains the position of the corner on the contour detected from the second image as the position information of the detection target point. In the example of FIG. 12, the position of the corner C2 is obtained. In this embodiment, the position of the corner specified in the coordinate system peculiar to the partial imaging camera 62 is used as the position information of the detection target point. The position information of the detection target point is not limited to the above example, and for example, the position and length of each edge of the base plate in the second image may be used as the position information of the detection target point. The position information of the detection target point thus obtained is sent to the control apparatus 9, and the control apparatus 9 calculates the coordinates of the detection target point as the second calculated coordinates from the position information.

5. Control Apparatus 9

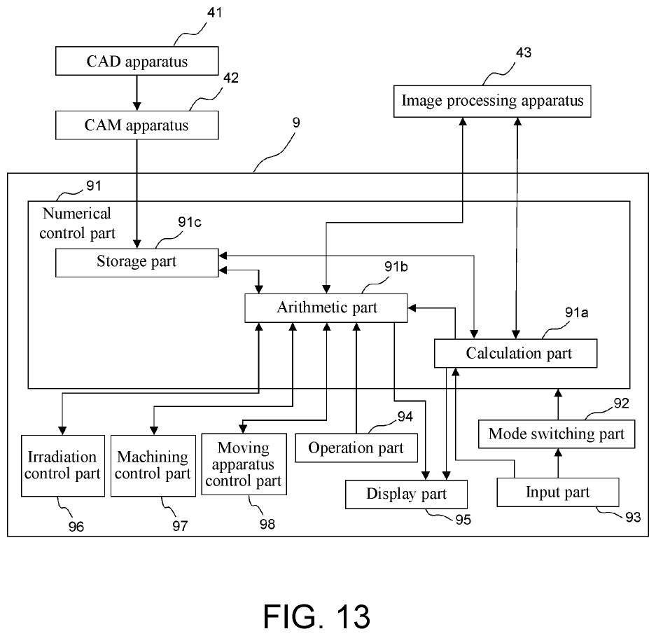

Next, the control apparatus 9 for controlling the apparatus 100 for additively manufacturing will be described. As shown in FIG. 13, the control apparatus 9 includes a numerical control part 91, a mode switching part 92, an input part 93, an operation part 94, a display part 95, and control parts 96, 97 and 98 of each apparatus that configures the apparatus 100 for additively manufacturing.

The “part” of the control apparatus 9 refers to, for example, a combination of hardware resources implemented by a circuit in a broad sense and information processing of software that may be concretely realized by these hardware resources. Further, various information is handled in this embodiment, and the information are represented by high and low signal values as a bit set of binary numbers configured by 0 or 1, and communication and calculation is executed on a circuit in a broad sense. Further, the circuit in a broad sense is a circuit realized by at least appropriately combining a circuit, a circuitry, a processor, a memory, and the like. That is, it includes an application specific integrated circuit (ASIC), a programmable logic apparatus (such as a simple programmable logic device (SPLD) and a complex programmable logic device (CLPD)), a field programmable gate array (FPGA) and the like. Further, such a program may be stored in a built-in storage part or may be stored in a non-transitory computer-readable recording medium. Further, a program stored in an external storage part may be read out and realized by so-called cloud computing.

A CAD apparatus 41 and a CAM apparatus 42 are installed outside the control apparatus 9. The CAD apparatus 41 is for creating three-dimensional shape data (CAD data) showing the shape and dimensions of the object to be built. The created CAD data is output to the CAM apparatus 42.

The CAM apparatus 42 is for creating operation procedure data (CAM data) of each apparatus configuring the apparatus 100 for additively manufacturing when building an object based on the CAD data. The CAM data includes, for example, data on the irradiation position of the laser beam B in each material layer 85 and data on the laser irradiation conditions of the laser beam B. The created CAM data is output to the numerical control part 91.

The apparatus 100 for additively manufacturing of this embodiment includes a fully automatic mode, a semi-automatic mode, and a manual mode as operation modes. The input part 93 is used by an operator to input an operation mode, and is configured by, for example, a touch panel, a keyboard, or a mouse. The mode switching part 92 switches the operation mode according to the input to the input part 93, and specifically outputs the information of the selected operation mode to the numerical control part 91.

The numerical control part 91 controls the image processing apparatus 43 provided outside the control apparatus 9, calculates the coordinates of the detection target point using the information sent from the image processing apparatus 43, and specifies the reference point and sets the building coordinate system. Further, the numerical control part 91 performs a calculation by the numerical control program on the CAM data by appropriately using the building coordinate system, and issues an operation command to the apparatus 100 for additively manufacturing.

The numerical control part 91 includes a calculation part 91a, an arithmetic part 91b, and a storage part 91c. Here, the calculation part 91a and the arithmetic part 91b may take different operations depending on the operation mode. The fully automatic mode is selected when the position information of the base plate 81 is obtained by analyzing the first image captured by the overall imaging camera 61. In the fully automatic mode, the arithmetic part 91b outputs an operation command for obtaining and analyzing the first image to the image processing apparatus 43. Then, the calculation part 91a calculates the coordinates of the detection target point in the machine coordinate system as the first calculated coordinates from the position information of the base plate 81 sent from the image processing apparatus 43. In this embodiment, as described above, the position of the corner is obtained by the image processing apparatus 43, and the result of conversion into the machine coordinate system is sent to the control apparatus 9 as the position information of the base plate 81. Therefore, when the corner is set as the detection target point, the coordinates of the detection target point sent from the image processing apparatus 43 may be used as they are as the first calculated coordinates.

In addition, the semi-automatic mode may be selected when it is difficult to obtain the position information of the base plate 81 by analyzing the first image due to the conditions such as the color and surface quality of the base plate 81, or when the size and disposition of the base plate 81 (for example, the distance of the base plate 81 from the frame 51) is known in advance. When the semi-automatic mode is selected, the operator needs to further input information for specifying the position of the detection target point such as the size and disposition of the base plate 81 into the input part 93 as additional position information of the base plate 81. The additional position information is sent to the calculation part 91a, and the calculation part 91a calculates the coordinates of the detection target point as the first calculated coordinates using the additional position information.

For the additional position information of the base plate 81 for which input is required in the semi-automatic mode, accuracy is required to roughly grasp the position of the detection target point in the build region R and appropriately set the second region A2. If the shape of the base plate 81 is relatively simple, or if the base plate 81 of the same shape has been disposed in the same manner in the past and the position may be detected and the data may be used, the semi-automatic mode may be selected, and the obtaining of the first image may be omitted, whereby the time required for position detection may be shortened.

The first calculated coordinates calculated in the fully automatic mode and the semi-automatic mode are sent to the arithmetic part 91b. In the fully automatic mode and the semi-automatic mode, the arithmetic part 91b creates a movement command of the partial imaging camera 62 using the first calculated coordinates and outputs the movement command to the moving apparatus control part 98 that controls the camera moving apparatus 7. The moving apparatus control part 98 controls the operation of the camera moving apparatus 7 based on the movement command. Specifically, the moving apparatus control part 98 makes the first drive mechanism 71, the second drive mechanism 72, and the third drive mechanism 73 operate in accordance with the movement command to move the partial imaging camera 62 in the horizontal direction and/or the vertical direction. As a result, the partial imaging camera 62 is disposed at a position where the second region A2 including the first calculated coordinates may be imaged, and the second image is obtained.

The manual mode may be selected when it is difficult to obtain the position information of the base plate 81 by analyzing the first image, and it is also difficult to input the additional position information of the base plate 81 because the base plate 81 has a particularly complicated shape or additive manufacturing is performed after performing another machining method in hybrid building. When the manual mode is selected, the calculation part 91a does not calculate the first calculated coordinates, and the operator operates the camera moving apparatus 7 by inputting to the operation part 94. Then, the camera moving apparatus 7 moves the partial imaging camera 62 according to the operation of the operator. Specifically, the arithmetic part 91b creates a movement command for the partial imaging camera 62 according to the input to the operation part 94, outputs the movement command to the moving apparatus control part 98, and the moving apparatus control part 98 operates the camera moving apparatus 7 to move the partial imaging camera 62 according to the movement command. The operator operates the camera moving apparatus 7 so that the detection target point is positioned at a predetermined position in the field of view of the partial imaging camera 62. For example, the partial imaging camera 62 is moved so that the detection target point is located at the center of the field of view of the partial imaging camera 62. The position information of the partial imaging camera 62 in the state where the movement of the partial imaging camera 62 is completed is obtained and sent to the control apparatus 9.

In the fully automatic mode and the semi-automatic mode, the calculation part 91a calculates the coordinates of the detection target point in the machine coordinate system as the second calculated coordinates from the position information of the detection target point sent from the image processing apparatus 43. In this embodiment, the position of the corner specified in the coordinate system peculiar to the partial imaging camera 62 is converted into the machine coordinate system by adding the position of the partial imaging camera 62 at the time of capturing the second image to obtain the second calculated coordinates. In addition, in the manual mode, the second calculated coordinates corresponding to the predetermined position of the field of view of the partial imaging camera 62 are calculated by using the position information of the partial imaging camera 62 obtained as described above. From the second calculated coordinates obtained in this way, the coordinates of the reference point in the machine coordinate system are specified, and for example, the building coordinate system is set with the reference point as the origin. The second calculated coordinates, the coordinates of the reference point, and the information of the set building coordinate system are sent to the arithmetic part 91b. The arithmetic part 91b performs a calculation by the numerical control program on the CAM data by appropriately using the building coordinate system, and outputs an operation command to the control part of each apparatus configuring the apparatus 100 for additively manufacturing in the form of a signal or data of the operation command value.

As described above, in the apparatus 100 for additively manufacturing of this embodiment, the operation mode may be switched by the mode switching part 92 of the control apparatus 9. As a result, the coordinates of the detection target point may be obtained regardless of the conditions such as the shape of the base plate 81, and the time required for position detection may be shortened.

The storage part 91c stores CAM data, the numerical control program, the position information of the base plate 81 and the detection target point, the first and second calculated coordinates, the coordinates of the reference point, the information of the building coordinate system, and the like. The display part 95 displays the position information of the base plate 81 and the detection target point, the operation command output by the arithmetic part 91b of the numerical control part 91, and the like.

The irradiation control part 96 controls the operation of the irradiation apparatus 13 based on the operation command. Specifically, the irradiation control part 96 controls the light source 31 to output the laser beam B at a predetermined laser power and irradiation timing. Further, the irradiation control part 96 controls the motor of the focus control unit 35 to move the focus control lens, whereby the laser beam B is adjusted to a predetermined beam diameter. Further, the irradiation control part 96 controls the first actuator and the second actuator to rotate the first galvano mirror 37a and the second galvano mirror 37b to desired angles, respectively, whereby the laser beam B is irradiated to a predetermined position of the material layer 85 on the base plate 81. The operation command for the irradiation control part 96, particularly the operation command related to the control of the actuator, is created based on the building coordinate system.

The machining control part 97 controls the operation of the machining apparatus based on the operation command. Specifically, the machining head is moved to a predetermined position. In addition, the tool is operated at a predetermined timing to perform machining such as cutting. The operation command to the machining control part 97, particularly the operation command related to the movement of the machining head, is created based on the building coordinate system. The above-mentioned control parts 96, 97, and 98 feed back the actual operation information of each apparatus to the numerical control part 91.

The configuration of the control apparatus 9 is not limited to the above configuration. For example, the operation part 94 may be provided on the camera moving apparatus 7, and the input to the operation part 94 may be transmitted to the camera moving apparatus 7 without going through the control apparatus 9, and information such as the actual movement amount of the partial imaging camera 62 may be sent from the operation part 94 to the control apparatus 9.

6. Method for Additively Manufacturing an Object

Next, a method for additively manufacturing an object using the apparatus 100 for additively manufacturing according to this embodiment will be described. The method of this embodiment includes a building coordinate system setting step, and a material layer forming step and a solidifying step that are performed thereafter.

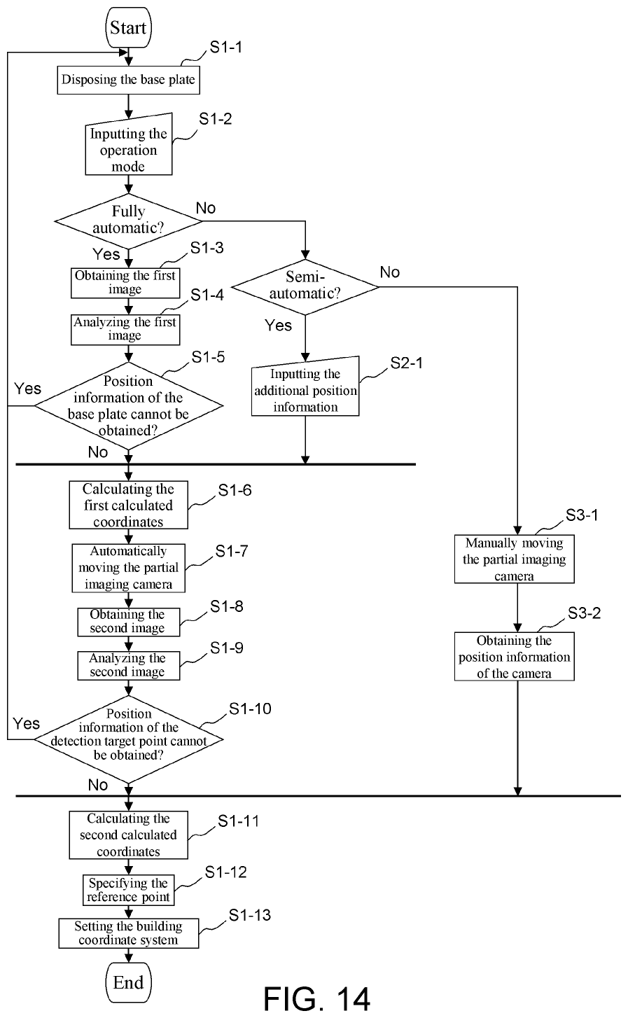

FIG. 14 is a flow chart showing a procedure for setting a building coordinate system that is performed prior to additively manufacturing. First, the base plate 81 is disposed in the build region R on the work table 5 (step S1-1). The operator inputs the operation mode in consideration of the conditions of the base plate 81, and the input part 93 takes in the input information, and the mode switching part 92 switches the operation mode (step S1-2).

When the fully automatic mode is selected, the overall imaging camera 61 images the first region A1 and obtains the first image (first image obtaining step, step S1-3). The first image is sent to the image processing apparatus 43, and the image processing apparatus 43 analyzes the first image to obtain the position information of the base plate 81 (first image analysis step, step S1-4). The position information of the base plate 81 is sent to the calculation part 91a of the control apparatus 9. The calculation part 91a converts the position information of the base plate 81 into the machine coordinate system, and calculates the coordinates of the detection target point as the first calculated coordinates (first calculated coordinates calculation step, step S1-6). If the position information of the base plate 81 cannot be obtained even though the analysis of the first image is executed, it is also possible to select the semi-automatic mode or the manual mode on the input part 93 to switch the operation mode (step S1-5).

When the semi-automatic mode is selected, the operator inputs the additional position information of the base plate 81 to the input part 93, and the input part 93 takes in the input information (step S2-1). The additional position information is sent to the calculation part 91a, and the calculation part 91a calculates the coordinates of the detection target point as the first calculated coordinates using the additional position information (step S1-6).

The first calculated coordinates are sent to the arithmetic part 91b, and the arithmetic part 91b creates a movement command of the partial imaging camera 62 using the first calculated coordinates, and the camera moving apparatus 7 automatically moves the partial imaging camera 62 based on the movement command (step S1-7). Then, the partial imaging camera 62 images the second region A2 and obtains the second image (second image obtaining step, step S1-8). The second image is sent to the image processing apparatus 43, and the image processing apparatus 43 analyzes the second image (second image analysis step, step S1-9) to obtain the position information of the detection target point. The position information of the detection target point is sent to the calculation part 91a of the control apparatus 9. If the position information of the detection target point cannot be obtained even though the analysis of the second image is executed, it is also possible to select the manual mode on the input part 93 to switch the operation mode (step S1-10).

When the manual mode is selected, the operator operates the camera moving apparatus 7 by inputting to the operation part 94 to move the partial imaging camera 62 (step S3-1). Then, the position information of the partial imaging camera 62 in the state where the movement is completed is obtained by the control apparatus 9 (step S3-2).

The calculation part 91a converts the position information of the detection target point into the machine coordinate system or uses the position information of the partial imaging camera 62, and calculates the coordinates of the detection target point as the second calculated coordinates (second calculated coordinates calculation step, step S1-11). Further, the coordinates of the reference point are specified from the second calculated coordinates (step S1-12), and the building coordinate system is set with the reference point as a reference (step S1-13).

After the building coordinate system is set by the above procedure, the material layer forming step and the solidifying step are performed. In the material layer forming step, the material powder is supplied to the upper surface of the base plate 81 disposed in the build region R to form the material layer 85. In the solidifying step, a predetermined irradiation region of the material layer 85 is irradiated with the laser beam B or an electron beam to form the solidified layer 86. The material layer forming step and the solidifying step are repeatedly performed.

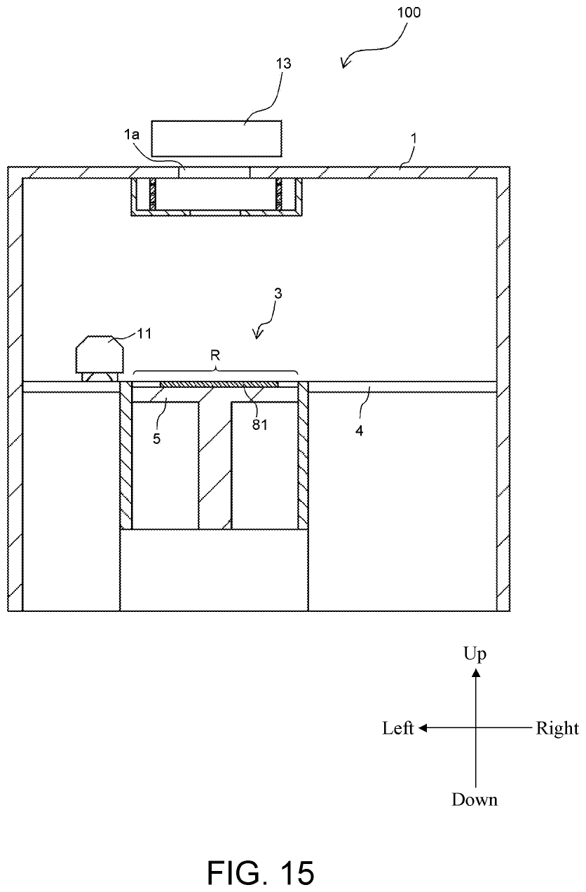

First, the material layer forming step is performed for a first time. As shown in FIG. 15, the height of the work table 5 is adjusted to an appropriate position with the base plate 81 placed on the work table 5. In this state, by moving the recoater head 11 from the left side to the right side in FIG. 15, a first layer of the material layer 85 is formed on the base plate 81.

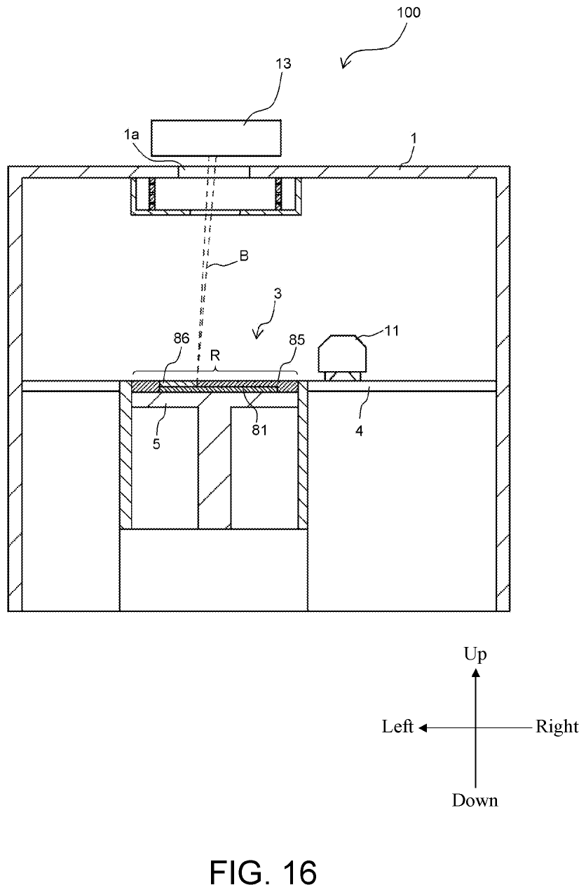

Next, the solidifying step is performed for a first time. As shown in FIG. 16, the first layer of the material layer 85 is solidified by irradiating a predetermined irradiation region of the first layer of the material layer 85 with the laser beam B or an electron beam, and a first layer of the solidified layer 86 is obtained.

Subsequently, the material layer forming step is performed for a second time. After forming the first layer of the solidified layer 86, the height of the work table 5 is lowered by one layer of the material layer 85. In this state, by moving the recoater head 11 from the right side to the left side of FIG. 16 in the build region R, a second layer of the material layer 85 is formed to cover the first layer of the solidified layer 86. Then, the solidifying step is performed for a second time. In the same manner as described above, the second layer of the material layer 85 is solidified by irradiating a predetermined irradiation region of the second layer of the material layer 85 with the laser beam B or an electron beam, and a second layer of the solidified layer 86 is obtained.

The material layer forming step and the solidifying step are repeated until a desired three-dimensional object is obtained, and multiple solidified layers 86 are laminated. Adjacent solidified layers 86 are strongly adhered to each other. Further, during or after building, cutting or the like is performed by a machining apparatus as necessary. After the completion of the additively manufacturing, the object may be obtained by discharging the unsolidified material powder and cutting chips.

Although various embodiments of the disclosure have been described above, these are presented as examples and are not intended to limit the scope of the disclosure. The novel embodiment may be implemented in various other forms, and various omissions, replacements, and changes may be made without departing from the gist of the disclosure. The embodiment and its modifications are included in the scope and gist of the disclosure, and are included in the scope of the disclosure described in the claims and the equivalent scope thereof.

What is claimed is:

1. An apparatus for additively manufacturing, comprising:
a chamber;
a work table;
a base plate;
a material layer forming apparatus;
an irradiation apparatus;
an imaging apparatus;
an image processing apparatus; and
a control apparatus,
wherein a build region is provided on the work table,
the chamber covers the build region,
the base plate is disposed in the build region,
the material layer forming apparatus forms a material layer on an upper surface of the base plate by supplying material powder,
the irradiation apparatus forms a solidified layer by irradiating the material layer with a laser beam or an electron beam,
the imaging apparatus images a first region including the entire build region to obtain a first image,
the image processing apparatus analyzes the first image to obtain position information of the base plate in the build region,
the control apparatus calculates coordinates of at least one detection target point as first calculated coordinates from the position information of the base plate,
the imaging apparatus images a second region which is a part of the first region and includes the first calculated coordinates to obtain a second image,
the image processing apparatus analyzes the second image to obtain position information of the detection target point in the build region, and
the control apparatus calculates coordinates of the detection target point as second calculated coordinates from the position information of the detection target point.

2. The apparatus for additively manufacturing according to claim 1, further comprising:
a camera moving apparatus,
wherein the imaging apparatus comprises an overall imaging camera and a partial imaging camera,
the overall imaging camera is fixed in the chamber and images the first region to obtain the first image,
the partial imaging camera is movably provided in the chamber and images the second region to obtain the second image,
the control apparatus creates a movement command of the partial imaging camera using the first calculated coordinates, and
the camera moving apparatus moves the partial imaging camera according to the movement command.

3. The apparatus for additively manufacturing according to claim 2, comprising a fully automatic mode and a semi-automatic mode as operation modes,
wherein the control apparatus comprises a mode switching part, a calculation part, and an input part,
the mode switching part switches the operation mode, and
in the fully automatic mode, the calculation part calculates the coordinates of the detection target point as the first calculated coordinates from the position information of the base plate to create the movement command, and in the semi-automatic mode, the calculation part calculates the coordinates of the detection target point as the first calculated coordinates from additional position information of the base plate input by the input part to create the movement command.

4. The apparatus for additively manufacturing according to claim 3, further comprising a manual mode as the operation mode, and
wherein an operation part for operating the camera moving apparatus is provided, and
the camera moving apparatus moves the partial imaging camera according to the movement command in the fully automatic mode and the semi-automatic mode, and moves the partial imaging camera according to an operation of the operation part by an operator in the manual mode.

5. The apparatus for additively manufacturing according to claim 1,
wherein the detection target point is located on an outer edge of the base plate in a plan view.

6. The apparatus for additively manufacturing according to claim 5,
wherein the detection target point is located at a corner of the base plate in a plan view.

7. A method for additively manufacturing an object, comprising:
a material layer forming step;
a solidifying step;
first and second image obtaining steps;
first and second image analysis steps; and
first and second calculation steps,
wherein in the material layer forming step, in a chamber covering a build region provided on a work table, material powder is supplied to an upper surface of a base plate disposed in the build region to form a material layer,
in the solidifying step, the material layer is irradiated with a laser beam or an electron beam to form a solidified layer,
in the first image obtaining step, a first region including the entire build region is imaged to obtain a first image,
in the first image analysis step, the first image is analyzed to obtain position information of the base plate in the build region,
in the first calculation step, coordinates of a detection target point on the base plate are calculated as first calculated coordinates from the position information of the base plate,
in the second image obtaining step, a second region which is a part of the first region and includes the first calculated coordinates is imaged to obtain a second image,
in the second image analysis step, the second image is analyzed to obtain position information of the detection target point in the build region, and
in the second calculation step, coordinates of the detection target point are calculated as second calculated coordinates from the position information of the detection target point.
